(19) United States
(12) Patent Application Publication
(10) Pub. No.: US 2014/0089024 A1
(43) Pub. Date: Mar. 27, 2014

(54) Control device for resource allocation

(71) Applicants: Jonathan David Mason, Waalre (NL); Dzmitry Viktorovich Aliakseyeu, Eindhoven (NL); Dirk Valentinus René Engelen, Heusden-Zolder (BE); Johannes Weda, Nijmegen (NL); Aaron Robert Houssian, Best (NL)

(72) Inventors: Jonathan David Mason, Waalre (NL); Dzmitry Viktorovich Aliakseyeu, Eindhoven (NL); Dirk Valentinus René Engelen, Heusden-Zolder (BE); Johannes Weda, Nijmegen (NL); Aaron Robert Houssian, Best (NL)

(73) Assignee: KONINKLIJKE PHILIPS N.V., EINDHOVEN (NL)

(21) Appl. No.: 14/119,659

(22) PCT Filed: May 8, 2012
(86) PCT No.: PCT/IB2012/052281

§ 371 Date: Nov. 22, 2013

(30) Foreign Application Priority Data
May 26, 2011 (EP) 11167669.8

(51) Int. Cl. G06Q 10/06

(52) U.S. Cl. CPC G06Q 10/0631
USPC 705/7.12

(57) ABSTRACT

The present invention relates to a control device for providing a recommendation for at least one physical environment for an activity and for providing a recommendation for at least one activity in a physical environment. Such a control device is suitable for users working in flexible office environments and can thus be used for easily locating spaces that suit the users' needs for the current work task. Using historical data mined from embedded sensors in the offices in conjunction with a user's preferences as to how he likes a location to be, a suitability rating can be generated in real time. This enables users to find locations that can suit not only their tangible needs (i.e. luminaires, furniture, equipment, windows etc.) but also their intangible and personal needs (i.e. temperature, light level, busyness, noise levels, humidity, activity etc.).

### FIELD OF THE INVENTION

The present invention relates in general to a control device and in particular to a control device, a method and a computer program product for providing a recommendation for at least one physical environment for an activity and for providing a recommendation for at least one activity in a physical environment.

### BACKGROUND OF THE INVENTION

More and more open plan office workspaces are currently being deployed. Also, flexible workspaces where workers (such as employees and users) do not have their own office or dedicated workstation are getting more common. In such physical environments workers must find a suitable location to work each day. Some companies are already practicing this way of working.

In such physical environments workers are often disturbed by other workers. Further, everyday it may take some time for each worker to find a suitable location to work. Also, depending on certain criteria, each worker may favor different locations ranging from dark and enclosed to bright and open, which may or may not be provided with task lights, spots, cocoon areas, etc.

The choice of location (i.e. physical environment) often depends on the type of work that is to be undertaken. For example, for reading documents it may be desirable to work in a quiet location with spot lighting. E-mails may be read while chatting with colleagues; writing activities or sorting out files are preferably performed in a bright but quiet location; projects on which people work in teams are preferably performed in a large meeting area. Thus, each activity may impose different demands on the location.

### SUMMARY OF THE INVENTION

It is therefore an object of the present invention to overcome these problems and provide means for giving a recommendation for at least one physical environment for an activity.

According to a first aspect of the invention, these and other objects are achieved by means of a control device for providing a recommendation for at least one physical environment for an activity, the control device being arranged to receive user input relating to at least one activity, access historical sensor data from at least one sensor associated with a physical environment to create a time line of sensor measurements for the physical environment, receive current sensor data from the at least one sensor associated with the physical environment to create a snapshot of sensor measurements for the physical environment, predict future environmental conditions for the physical environment by combining the time line of sensor measurements with the snapshot of sensor measurements, correlate the predicted future environmental conditions with data pertaining to the at least one activity, and provide a result of the correlation to a user interface so as to provide a recommendation for the at least one physical environment for the at least one activity.

According to a second aspect of the invention, the above and other objects are achieved by means of a control device for providing a recommendation for at least one activity in a physical environment, the control device being arranged to receive user input relating to a physical environment, access historical sensor data from at least one sensor associated with the physical environment to create a time line of sensor measurements for the physical environment, receive current sensor data from the at least one sensor associated with the physical environment to create a snapshot of sensor measurements for the physical environment, predict future environmental conditions for the physical environment by combining the time line of sensor measurements with the snapshot of sensor measurements, correlate the predicted future environmental conditions with data pertaining to at least one activity, and provide a result of the correlation to a user interface so as to provide a recommendation for the at least one activity in the physical environment.

The control device may thus enable efficient resource allocation and management by taking into account previous and current sensor data.

The user interface may be an integrated part of the control device. This may advantageously result in a compact control device.

The control device may be a mobile phone. The control device may thus be embodied as a (personal and) portable device.

The historical and/or current sensor data may relate to at least one tangible and/or intangible measurement. The at least one tangible measurement may be indicative of the number and/or type of luminaires, furniture, computer equipment and/or windows. The at least one intangible measurement may be indicative of the noise level, light level, temperature, air quality, humidity, air and/or condition level.

The control device may further be arranged to receive manually inputted user input relating to the physical environment and/or the data pertaining to the at least one activity.

The control device may further be arranged to store the snapshot of sensor measurements for the physical environment in an environment profile. The control device may further be arranged to access the at least one stored environment profile and compare the at least one stored environment profile with a snapshot of sensor measurements for a current physical environment.

The data pertaining to at least one activity may be associated with at least one calendar item. The at least one calendar item may be an appointment item, meeting item, or event item. The calendar may be a Microsoft Outlook calendar, a Google calendar, or the like. The control device may further be arranged to access data associated with at least one further calendar item, and to provide an indication of the at least one further calendar item to the user interface.

According to a third aspect of the invention, the above and other objects are achieved by means of a method of providing a recommendation for at least one physical environment for an activity, said method comprising receiving user input relating to at least one activity, accessing historical sensor data from at least one sensor associated with a physical environment to create a time line of sensor measurements for the physical environment, receiving current sensor data from the at least one sensor associated with the physical environment to create a snapshot of sensor measurements for the physical environment, predicting future environmental conditions for the physical environment by combining the time line of sensor measurements with the snapshot of sensor measurements, correlating the predicted future environmental conditions with data pertaining to the at least one activity, and providing a result of the correlation to a user interface so as to provide a recommendation for the at least one physical environment for the at least one activity.

According to a fourth aspect of the invention, the above and other objects are achieved by means of a method of providing a recommendation for at least one activity in a physical environment, said method comprising receiving user input relating to a physical environment, accessing historical sensor data from at least one sensor associated with the physical environment to create a time line of sensor measurements for the physical environment, receiving current sensor data from the at least one sensor associated with the physical environment to create a snapshot of sensor measurements for the physical environment, predicting future environmental conditions for the physical environment by combining the time line of sensor measurements with the snapshot of sensor measurements, correlating the predicted future environmental conditions with data pertaining to at least one activity, and providing a result of the correlation to a user interface so as to provide a recommendation for the at least one activity in the physical environment.

According to a fifth aspect of the invention, the above and other objects are achieved by means of a computer program product stored on a non-volatile storage medium and comprising software instructions which, when executed on a processor, cause the processor to perform a method as disclosed above.

The disclosed embodiments thus provide means for people working in flexible office environments to locate easily spaces which suit their needs for the current work task. A suitability rating can be generated in real time by using historical data mined from embedded sensors in the offices in conjunction with a user's preferences as to how he would like a location to be, for example by indicating an activity to be performed. This enables employees to find locations which can suit not only their tangible needs (i.e. luminaires, lighting infrastructure, furniture, equipment, windows etc.) but also their intangible and personal needs (i.e. temperature, artificial and natural light level, busyness, noise levels, humidity, temperature, activity, air quality etc.). The disclosed embodiments thus provide means to understand the past, the present and the predicted future of an environment (tangible aspects) and the atmosphere (intangible aspects). The disclosed embodiments will thus enable employees working in flexible office spaces to decide whether a location is suitable for their needs, based on rational and real information rather than a quick, subjective judgment as is the case at this moment in time.

It is noted that the invention relates to all possible combinations of features recited in the claims.

### BRIEF DESCRIPTION OF THE DRAWINGS

These and other aspects of the present invention will now be described in more detail with reference to the appended drawings showing embodiment(s) of the invention, in which

FIGS. 1-2 illustrate functional block diagrams of systems according to embodiments;

FIG. 3 illustrates a user interface of a control device according to embodiments; and

FIGS. 4-5 are flowcharts of methods according to embodiments.

### DETAILED DESCRIPTION OF THE EMBODIMENTS

The present invention will now be described more fully with reference to the accompanying drawings, in which currently preferred embodiments of the invention are shown. The invention may, however, be embodied in many different forms and should not be construed as limited to the embodiments set forth herein; rather, these embodiments are provided for thoroughness and completeness, and fully convey the scope of the invention to the person skilled in the art. Like reference characters refer to like elements throughout.

The present invention will be described in the context of an activity which is to be performed in one physical environment selected from a plurality of different physical environments so as to estimate the correlation between the activity and the physical environment(s). In turn, each physical environment may be associated with a plurality of different settings and measurements. These settings and measurements may be used when performing the correlation. The settings and measurements may be sensed or measured by a plurality of sensors.

Such a plurality of physical environments may represent a scenario where different types of workplaces, such as open plan office workspaces, are deployed in a single workplace, and where each type of workplace corresponds to one type of physical environment. When persons working in such a workplace arrive at the building where they work, their first task of the day commonly is to find and select a suitable place to work, depending on the kind of work to be performed, i.e. the activity that is to be performed. If a first location is selected and it is later discovered that the selected location is not suitable for the work to be performed (e.g. the location is too noisy, too busy, too dark, too bright, too hot, etc.), the worker could be forced to pack up his/her things and start searching for another, more suitable second location. This process could represent a major impediment to an employee's performance, since working conditions can seriously affect concentration and productivity. Being able to find a good place to work (i.e. to find a suitable physical environment for a certain activity) straight away will save the employee time and effort and will reduce office stress and frustration. The indication that the location is too noisy, too busy, too dark, too bright, too hot, and the like, may be reflected by values of parameters stored in a matrix (or vector) relating to measurements and/or settings of sensors and/or actuators in each respective physical environment. Herein are disclosed means to ease and smoothen the process of finding a good place to work that suits an employee's individual needs and desires.

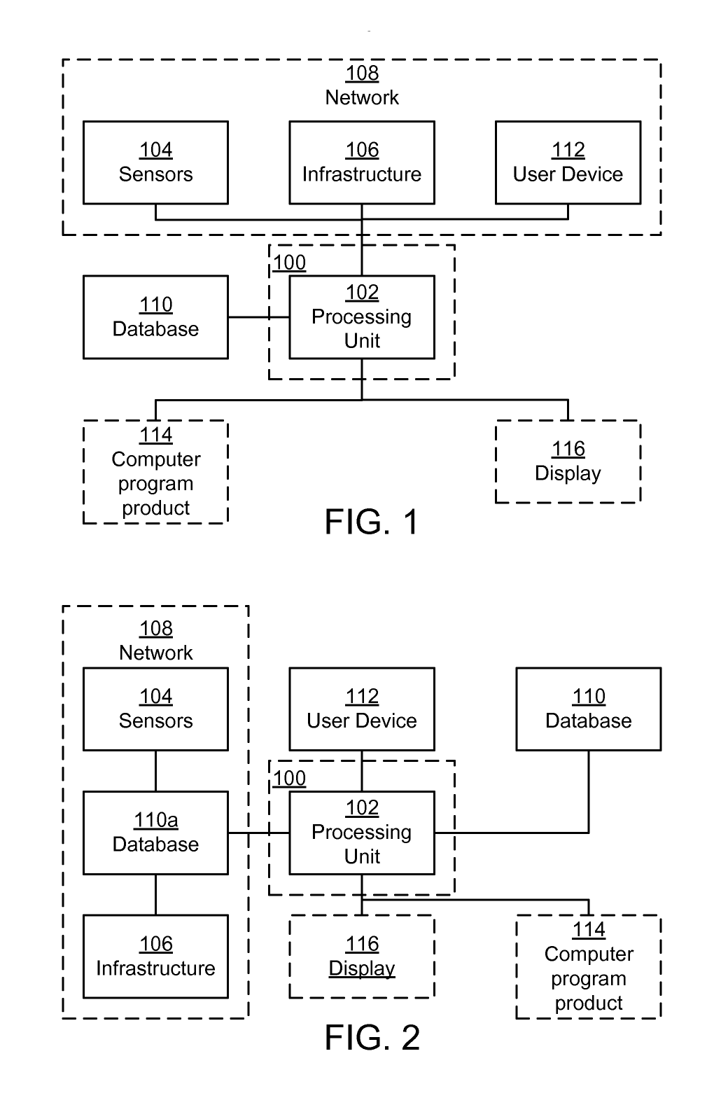

FIG. 1 illustrates, by way of a number of functional blocks, a system according to embodiments of the present invention. The system comprises a plurality of sensors 104 which may further comprise, or be operatively coupled to, actuators. The plurality of sensors 104 are arranged to sense data from the physical environment in which they are located and to (locally) store the sensed data. The sensors 104 may thus constantly mine data from the location where they are present. The sensors 104 may typically be light sensors arranged to sense light levels, audio sensors arranged to sense audio and/or noise levels, temperature sensors arranged to sense temperature, humidity sensors arranged to sense humidity, air quality sensors arranged to sense air quality, image sensors arranged to sense photographic or infrared images and the like, and hence the sensed data may correspond thereto. The system typically comprises a plurality of sensors 104 of such different types.

The system further comprises a plurality of infrastructure elements 106 representing further actuators and devices producing output. The infrastructure elements 106 may thus represent lighting infrastructures, audio outputs, visual outputs, scent, air conditioning control, air filtration, sound masking/dampening etc. These actuators and output devices may also broadcast their presence and status in any given environment.

The plurality of sensors 104 and the plurality of infrastructure elements 106 may be part of, or operatively coupled to, a network 108. The network 108 may be an internal network (intranet) or part of an external network (internet). The network 108 may thus be used by the plurality of sensors 104 and the plurality of infrastructure elements 106 to broadcast their presence, status, and/or produced data to other devices.

Within the physical environments in which data is sensed and processed by the plurality of sensors 104 and the plurality of infrastructure elements 106, people will be present much of the time and thus will also influence and provide data for the sensors to mine. Particularly, people may be able to provide personal information to the system relating to their current physiological and biological situation (sleepy, tired, energized, happy, etc) and/or to provide pre-programmed information stored on (personal) user devices 112 operatively coupled to the network 108. Such pre-programmed information may inter alia relate to working schedules, appointments, and preferences.

As will be discussed in more detail below, data from the plurality of sensors 104, the infrastructure elements 106 and the user devices 112 may be useful, so that people can find out whether a location can physically meet their needs or desires. The data from the plurality of sensors 104, the infrastructure elements 106 and the user devices 112 may be (wirelessly) transmitted through the network 108 to a device which has authorization to receive the sensed data.

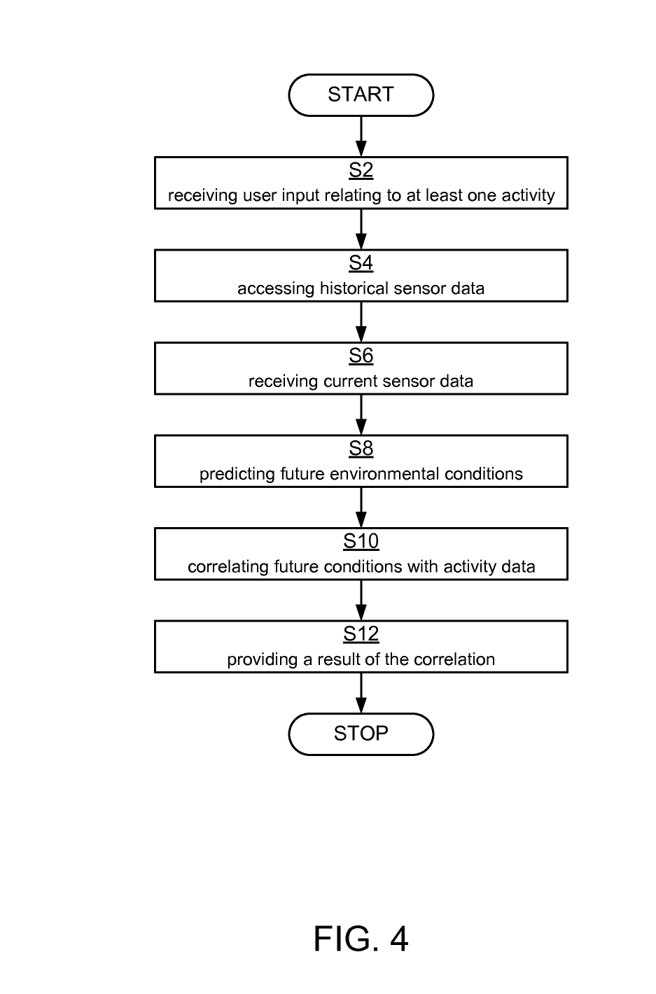

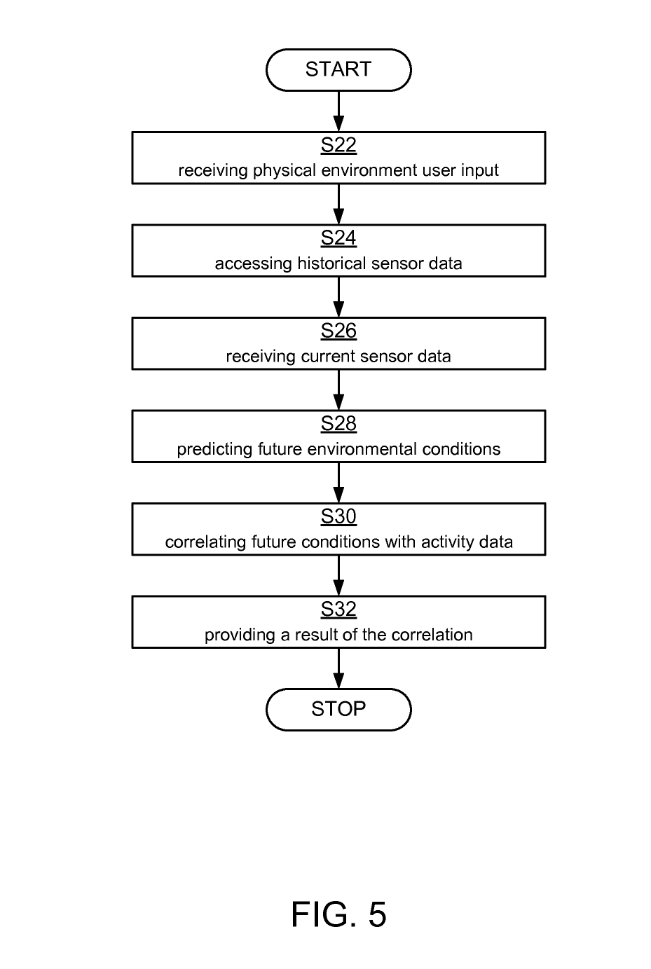

Particularly, the sensed data may be received by a control device 100 which preferably comprises a processing unit 102. The control device 100 may be a central server device or a personal device, such as a mobile phone. The streams of data received from the plurality of sensors 104, the infrastructure elements 106 and/or the user devices 112 may thus be monitored and analyzed by the processing unit 102 of the central or individual control device 100. The control device 100 may in particular be arranged for providing a recommendation for at least one physical environment for a given specific activity. Likewise, the control device 100 may in particular be arranged for providing a recommendation for at least one activity in a given specific physical environment. In order to do so, the control device 100 (particularly the processing unit 102 thereof) needs to be arranged so as to perform a number of functionalities. These functionalities will now be described with reference to the flowcharts illustrated in FIGS. 4 and 5. The functionalities may be hardwired in the (processing unit 102 of the) control device 100. Alternatively, the (processing unit 102 of the) control device 100 may access a computer program product (114) which comprises software instructions. When the software instructions are executed on the processing unit 114, this causes the processing unit 114 to perform the functionality. The software instructions may be stored on a non-volatile storage medium which may be an integral part of, or operatively coupled to, the control device 100.

The control device 100 may receive user input relating to at least one activity, step S2. The activity may correspond to an activity that a user is to perform. Typical activities include, but are not limited to, reading documents, reading/writing E-mails, writing or sorting out files, having a person-to-person meeting, working on a project in a team. The received activity may be stored as a matrix (or vector) in the control device 100, wherein the values of the elements of the matrix (or vector) reflect the received activity. Thus, different activities may be distinguished through the matrix (or vector) values. For example, each activity (such as reading documents, reading/writing E-mails, writing or sorting out files, having a person-to-person meeting, working on a project in a team) may be reflected by one or more elements of the matrix (or vector).

The data pertaining to at least one activity may be associated with at least one calendar item. The at least one calendar item may be an appointment item, meeting item, or event. The control device may be further arranged to access data associated with at least one further calendar item, and to provide an indication of the at least one further calendar item to the user interface. Thus, the user may see ongoing and future planned activities for the physical environment.

The control device 100 may also use input relating to a particular physical environment, step S22. The physical environment may correspond to a location where a user is to perform an activity. Typical physical environments include, but are not limited to, workplaces with a fixed number of workspaces in an open plan office, meeting rooms, personal offices. The physical environment may also relate to fixtures and furniture. Information regarding the physical environment may be received in the form of manual user input. Thus, a user may specify a particular physical environment in which he/she is to perform an activity. Properties of each physical environment may be stored as values in a matrix (or vector).

Upon reception of the at least one activity or the physical environment, the (processing unit 102 of the) control device 100 may record a timeline of sensor activity or a history of the states of (different) physical environments. This can provide historical information with respect to how a physical environment has been used and the type of activities that have taken place in the physical environment. Particularly, for this purpose, the (processing unit 102 of the) control device 100 accesses historical sensor data from at least one sensor 104 associated with the physical environment, step S4, S24. As a result, the control device 100 creates a (virtual) time line of sensor measurements for the physical environment. The processing unit 102 may then monitor and interpret them and provide feedback information in a meaningful way to users when they need it. The accessed historical sensor data may be stored in a database 110. The database 110 may be part of the control device 100 or it may be operatively coupled to the control device 100.

Further, the control device 100 may maintain an up to date snapshot of the current environmental situation of the particular locations concerned. Particularly, for this purpose, the control device 100 receives current sensor data, from the at least one sensor 104, associated with the physical environment to create a snapshot of sensor measurements for the physical environment, step S6, S26. The thus generated snapshot of sensor measurements for the physical environment may be stored in an environment profile. The environment profile may be stored in the database 110. Such stored environment profiles may later be accessed by the control device 100 in order for the control device 100 to compare the at least one stored environment profile with a snapshot of sensor measurements for a current physical environment.

Then, the historical environmental states stored in the database 110 may be linked to the current snapshot data. The combined historical data and the current snapshot data may then be extrapolated to the future, thus providing a forecast of how the physical environment may change over time. Particularly, for this purpose, (processing unit 102 of the) control device 100 predicts, by combining the time line of sensor measurements with the snapshot of sensor measurements, future environmental conditions for the physical environment, step S8, S28. The historical and/or current sensor data may in particular relate to at least one tangible and/or intangible measurement. The at least one tangible measurement may be indicative of the number and/or type of luminaires, furniture, computer equipment and/or windows. The at least one intangible measurement may be indicative of noise level, audio level, light level, temperature, air quality, humidity, and/or air conditioning level. The values of the tangible and intangible measurements may be stored as values in a matrix (or vector) for each physical environment.

The predicted future environmental conditions could be linked to recommender systems and room reservation systems, so that employees can see in advance if a meeting room is a suitable location for their needs. Likewise, the predicted future environmental conditions could be directly set off against at least one activity. Particularly, in order to set off the predicted future environmental conditions against at least one activity, the (processing unit 102 of the) control device 100 correlates the predicted future environmental conditions with data pertaining to the at least one activity, step S10, S30.

The correlation may be performed as a matrix (or vector) correlation. For example, as noted above, each room in a building (wherein each room corresponds to a respective physical environment) could be represented by a matrix (or vector) of historical and current sensor data measured for the room. Similarly, each activity could be represented by values of a number of settings pertaining to tangible and intangible aspects. These values could in turn be represented by a matrix (or vector). Then, the matrix (or vector) representing the sensor data could be correlated with the matrix (or vector) representing the activity, wherein the correlation result provides an indication of the suitability.

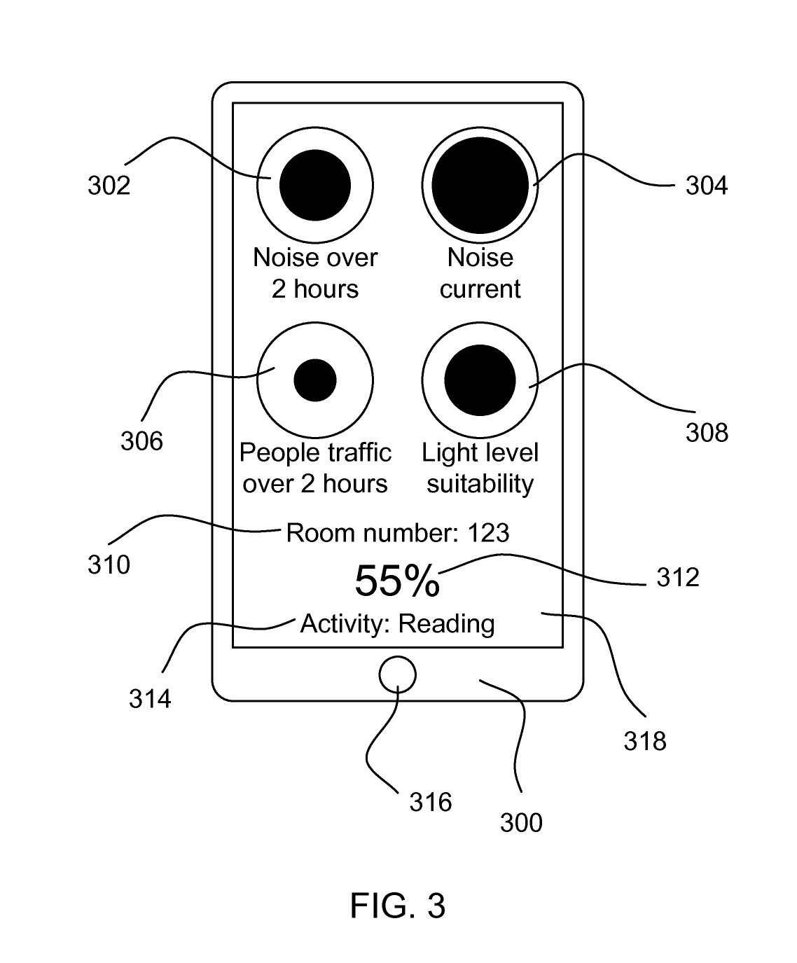

Values in the matrices (or vectors) could be scalable, weighted, or have different details levels. For example, a first representation could include average values throughout a period of one day, whereas a second representation being more detailed than the first representation could include average values for each hour. Properties such as scaling, weighting, or different details levels may be applied to both the sensor matrix (or vector) and the preference/activity matrix (or vector). Feedback in this respect could be timed, thereby enabling the control device 100 to provide the recommendation that a certain physical environment (say, “Room number: 123”) will be suitable for a certain activity (say, “Activity: Reading”) for two hours or in two hours, see FIG. 3 and the description thereof.

In addition, personal preferences (instantaneously generated or previously stored) do not have to be associated with a particular activity. For example, a user may have preferences for a higher than average light level because of problems with his eyesight, which will be an additional prerequisite irrespective of the user's (planned) activity. Such personal preferences may for example be stored in the database 110 or in the user device 112 and be accessible by the control device 100. Further, after spending a few hours in a particular environment, the user could record or otherwise mark some or all properties of this environment as most suitable for a specific activity. The combination of properties and activity may be stored in the database 110 or in the user device 112 and be accessible by the control device 100 and taken into consideration by the control device when performing correlations. Hence, the next time the user looks for an area for the same specific activity, physical environments that are very similar (i.e. having similar tangible and/or intangible properties) to the recorded environment may show a high level of correlation. Thus, the control device 100 may be arranged to receive such recording or markings and take them into consideration when performing the correlation.

Information resulting from the correlation could be provided in a meaningful and timely manner to the people who have expressed an interest in or need to know such information. Particularly, the information may be provided to a display 116. The display 116 may be part of the control device 100 or it may be operatively coupled to the control device 100. Particularly, for this purpose, if the control device 100 receives user input relating to at least one activity, it may provide a result of the correlation to a user interface so as to provide a recommendation for the at least one physical environment for the at least one activity, step S12. Likewise, if the control device 100 receives user input relating to a physical environment, it may provide a result of the correlation to a user interface so as to provide a recommendation for the at least one activity in the physical environment, step S32. Thus, based on collected historical data and snapshot data, the control device attempts to predict the appropriateness of the physical environment for a particular user—defined activity. The control device may then act as a dynamic recommender by remaining in a constant monitoring loop for monitoring the incoming data streams and thus update the recommendation in real time for the users. The system could also work in reverse, i.e. rather than the employee providing a preferred activity, the system could suggest, based on the data mined, what activities are suited for this area in its current state. In addition, the system can provide an overview of the activities currently undertaken and planned by people present in the environment.

The system of FIG. 2 is similar to the system of FIG. 1 as disclosed above. The system of FIG. 2 comprises a plurality of sensors 104 arranged to sense data from the physical environment in which they are located and to (locally) store the sensed data. The system further comprises a plurality of infrastructure elements 106 representing further actuators and devices producing output. A network 108 may be used by the plurality of sensors 104 and the plurality of infrastructure elements 106 to broadcast their presence, status, and/or produced data to other devices. For example, status and/or produced data may be stored in the common database 110a. Information may also be provided to the system from (personal) user devices 112. Accessed historical sensor data may be stored in a database 110. The database 110 may be part of the control device 100 or it may be operatively coupled to the control device 100.

As in FIG. 1, the system of FIG. 2 also comprises a control device 100 comprising a processing unit 102. In the case that data from the plurality of sensors 104 and from the plurality of infrastructure elements 106 is stored in the database 110a, the processing unit 102 can directly access the data in the database 110a without accessing the plurality of sensors 104 or the plurality of infrastructure elements 106 themselves.

Further, as noted above, the control device 100 may be a central server device or a personal device, such as a mobile phone. The (processing unit 102 of the) control device 100 may access a computer program product (114) which comprises software instructions to perform a functionality of the control device 100. The software instructions may be stored on a non-volatile storage medium which may be an integral part of the control device 100 or they may be operatively coupled to the control device 100. Information generated by the control device 100 may be provided to a display 116. The display 116 may be part of the control device 100 or it may be operatively coupled to the control device 100.

The processing and analysis as disclosed above with reference to the flowchart of FIG. 4 may be completed in the control device 100. For example, if a new sensor 104 is added to the system (e.g. a sensor that provides information about the number of people passing is installed), the new sensor does not have to be explicitly integrated into any network and can operate independently thereof as long as the control device 100 can harvest data stored on it. By virtue thereof, flexible and easily upgradable systems can be provided. When the user activates his or her personal control device 100, the control device 100 can connect to the sensors 104 and infrastructure elements 106 present in the vicinity of the control device 100 and gather the historical data. The control device 100 may, for example, connect to the sensors 104 and infrastructure elements 106 present in the vicinity of the control device 100 by means of infrared communications (such as IrDA communications), short-range radio communications (such as Bluetooth), or RFID communications (where the sensors 104 and infrastructure elements 106 have RFID tags and the control device 100 has an RFID tag reader). The embodiment of FIG. 2 does not require the user to send any personal information (e.g. preferences) to the system except authentication, thus preserving privacy.

Consequently, processing and collecting of data can be performed on different devices (e.g. a personal control device, a central server for the sensor infrastructure, or on every sensor separately). The data is then matched with the activity chosen and personal preferences and recommendations can be given.

FIG. 3 illustrates a user interface of a control device 300 according to embodiments. The control device 300 is similar to the control device 100 of FIG. 1 and FIG. 2. The control device 100 comprises means 316 for receiving user input and means 318 for displaying output. The means 316 for receiving user input may be an actuator, a button, or the like. The means 318 for displaying output may be a display. The display may be touch-sensitive, so that the control device 300 can receive user input by user interaction with the display 318.

In the illustrative example of FIG. 3, the suitability for an activity denoted “Activity: Reading” illustrated at reference numeral 314 has been calculated for a physical environment denoted “Room number: 123” as illustrated at reference numeral 310. A filtration algorithm may be used, so that the information may be displayed on, for example, a graphical user interface, in an easy to understand format. In the illustrative example of FIG. 3, a filtration algorithm has been applied which results in one general aspect and four specific aspects relating to the suitability for the activity “Reading” in the physical environment “Room number: 123”. The general aspect as illustrated at reference numeral 312 indicates that the activity “Reading” in the physical environment “Room number: 123” is associated with a general recommendation of “55%”. The four specific aspects relate to the properties “Noise in 2 hours” at reference numeral 302, “Noise current” at reference numeral 304, “People traffic in 2 hours” at reference numeral 306, and “Light level suitability” at reference numeral 308 for the physical environment. In the illustrative example of FIG. 3, the resulting value of the general aspect is indicated as a percentage, whereas the resulting values of the specific aspects are indicated as semi-filled circles, where the amount of filling (black) indicates the suitability for the activity in relation to the respective specific aspects. However, other specific aspects and ways to illustrate the same are equally possible. Also, the user interface may list more than one activity and/or more than one physical environment.

In order for the control device 300 to provide a recommendation for the physical environment “Room number: 123” for the at least one activity “Activity: Reading”, or to provide a recommendation for the activity “Activity: Reading” in the physical environment “Room number: 123”, the control device 300 has performed processing and analysis as disclosed above with reference to the flowchart of FIG. 4. User input with respect to “Room number: 123” and/or “Activity: Reading” may thus have been received by the control device 300 in order for the control device 300 to provide correlation results pertaining to the four specific aspects and the one general aspect.

As noted above, the control device may be a mobile phone. A computer program product comprising software instructions may thus be provided in the form of application software which may be downloaded to the control device 300 from a server. When executed on the control device 300, the application software thus collects historical and current sensor data in order to calculate a recommendation. Alternatively, the application software may access a central server at which the calculations and data gathering may be performed.

The person skilled in the art will realize that the present invention is by no means limited to the preferred embodiments described above. On the contrary, many modifications and variations are possible within the scope of the appended claims. The present invention can for example be extended to other spaces that are (or can readily be) provided with a network of data mining sensors, such as waiting areas, public outdoor spaces, in order to find a quiet spot in an airport or avoid crowded spaces in a public park. Moreover, although the disclosed embodiments have been given in an office domain context, other domains may also be of interest for the present invention, such as hospitality or retail where a visual merchandiser can easily see whether or not the lighting infrastructure can render a particular scene for a shop window display.

1. A control device for providing a recommendation for at least one physical environment for an activity, which control device is arranged to
receive user input relating to at least one activity;
access historical sensor data from at least one sensor associated with a physical environment to create a time line of sensor measurements for the physical environment;
receive current sensor data from the at least one sensor associated with the physical environment to create a snapshot of sensor measurements for the physical environment;
predict, by combining the time line of sensor measurements with the snapshot of sensor measurements and extrapolating the combined historical sensor data and the snapshot of sensor measurements to the future, future environmental conditions for the physical environment;
correlate the predicted future environmental conditions with data pertaining to the at least one activity; and
provide a result of the correlation to a user interface so as to provide a recommendation for the at least one physical environment for the at least one activity.

2. A control device for providing a recommendation for at least one activity in a physical environment, which control device is arranged to
receive user input relating to a physical environment;
access historical sensor data from a least one sensor associated with the physical environment to create a time line of sensor measurements for the physical environment;
receive current sensor data from the at east one sensor associated with the physical environment to create a snapshot of sensor measurements for the physical environment;
predict, by combining the time line of sensor measurements with the snapshot of sensor measurements and extrapolating the combined historical sensor data and the snapshot of senor measurement to the future, future environmental conditions for the physical environment;
correlate the predicted future environmental conditions with data pertaining to at least one activity; and
provide a result of the correlation to a user interface so as to provide a recommendation for the at least one activity in the physical environment.

3. The control device according to claim 1, wherein the user interface is an integrated part of the control device,

4. The control device according to claim 1, wherein the control device is a mobile phone.

5. The control device according to claim 1, wherein the historical and/or current sensor data relates to at least one tangible and/or intangible measurement.

6. The control device according to claim 5, wherein the at least one tangible measurement is indicative of number and/or type of luminaires, furniture, computer equipment and/or windows, and wherein the at least one intangible measurement is indicative of noise level, audio level, light level, temperature, air quality, humidity, and/or air conditioning level.

7. The control device according to claim 1, further arranged to receive manually inputted user input relating to the physical environment and/or the data pertaining to the at least one activity.

8. The control device according to claim 1, further arranged to store the snapshot of sensor measurements for the physical environment in an environment profile.

9. The control device according to claim 8, further arranged to access the at least one, stored, environment profile and compare the at least one, stored, environment profile with a snapshot of sensor measurements for a current physical environment.

10. The control device according to claim 1, wherein the data pertaining to at least one activity is associated with at least one calendar item.

11. The control device according to claim 10, wherein the at least one calendar item is an appointment item, meeting item, or event item.

12. The control device according to claim 10, further arranged to access data associated with at least one further calendar item and provide an indication of the at least one further calendar item to the user interface.

13. A method of providing a recommendation for at least one physical environment for an activity, the method comprising
receiving user input relating to at least one activity;
accessing historical sensor data from at least one sensor associated with a physical environment to create a time line of sensor measurements for the physical environment;
receiving current sensor data from the at least one sensor associated with the physical environment to create a snapshot of sensor measurements for the physical environment;
predicting, by combining the time line of sensor measurements with the snapshot of sensor measurements and extrapolating the combined historical sensor data and the snapshot of sensor measurements to the future, future environmental conditions for the physical environment;
correlating the predicted future environmental conditions with data pertaining to the at least one activity; and
providing a result of the correlation to a user interface so as to provide a recommendation for the at least one physical environment for the at least one activity.

14. A method of providing a recommendation for at least one activity in a physical environment, the method comprising
receiving user input relating to a physical environment;
accessing historical sensor data from at least one sensor associated with the physical environment to create a time line of sensor measurements for the physical environment;
receiving current sensor data from the at least one sensor associated with the physical environment to create a snapshot of sensor measurements for the physical environment;
predicting, by combining the time line of sensor measurements with the snapshot of sensor measurements and extrapolating the combined historical sensor data and the snapshot of sensor measurements to the future, future environmental conditions for the physical environment;
correlating the predicted future environmental conditions with data pertaining to at least one activity; and
providing a result of the correlation to a user interface so as to provide a recommendation for the at least one activity in the physical environment.

15. A computer program product stored on a non-volatile storage medium and comprising software instructions which, when executed on a processor, cause the processor to perform a method according to claim 13.
